(19) United States
(12) Patent Application Publication
(10) Pub. No.: US 2002/0043609 A1
(43) Pub. Date: Apr. 18, 2002

(54) Assembling element

(76) Inventors: Michel Vulin, Oyonnax (FR); Marc Gagniere, Arbent (FR)

Correspondence Address: NATH & ASSOCIATES PLLC, 6th Floor, 1030 15TH Street NW, Washington, DC, 20005, US

(21) Appl. No.: 09/896,099

(22) Filed: Jul. 2, 2001

(30) Foreign Application Priority Data
Jul. 13, 2000 (FR) 00 09188

(51) Int. Cl. F16M 11/00; A47G 29/00

(52) U.S. Cl. 248/694

(57) ABSTRACT

The assembling element according to the invention is intended to be laid on a supporting surface with other, similar elements, in the manner of tiling. The element comprises a decorative assembling plate which is made in one piece and of which the edges form male and female sides for assembling. The male side comprises a connection strip which is intended to be disposed against the supporting surface and which is joined to its exposed face by a projection of the male side. This strip presents a boss parallel to the edge of the plate. A female side presents a free end which is joined to its exposed face by a projection of the female side. A space for connection, adapted to contain the boss of a male side of an adjacent element, is hollowed beneath the plate.

### FIELD OF THE INVENTION

The present invention relates to an assembling element intended to be arranged on a supporting surface with other similar elements so as to form an assembly covering this supporting surface at least partially, for example in the manner of tiling, the element comprising two adjacent sides, called male sides, which are provided with a connection strip and two other adjacent sides, called female sides, one male side of one assembling element being intended to cooperate with a female side of a similar assembling element in order to assemble said elements.

### BACKGROUND OF THE INVENTION

In order to cover a planar surface, it is known to lay tiles, arranged separately and fixed with the aid of a mortar. The possibility of making parquet floors of which the strips are joined to each other by a system of complementary rebates and tongues, is also known.

The drawback of tiling is its cost price and the difficulty of laying. Similarly, the cost price of the parquet strips is relatively high and is increased due to the necessary presence of rebates and tongues.

Patent Application FR 2 752 887 discloses an assembling element of the type described above. In that case, this element is made by the superposition of a plurality of plates arranged with respect to one another so as to form at least one zone of projection and at least one complementary standback zone, which allow the assembling of the elements with respect to one another. The assembling elements of this type give overall satisfaction, but they remain relatively expensive to manufacture due to the necessary laminating between the different plates which compose them and to the necessity of precise positioning of the latter with respect to one another. Furthermore, it is difficult to ensure tightness in the zones of join between the different assembling elements, which limits the possibilities of application.

### SUMMARY OF THE INVENTION

It is an object of the present invention to improve an assembling element of the type described hereinbefore, in order to simplify the constitution thereof, while improving its sealing performances in the zones of join between the different elements.

This object is attained in that the assembling element according to the invention comprises a decorative assembling plate which is made in one piece and of which the edges form said male and female sides, this plate presenting a substantially planar exposed face which is intended to be exposed when the element is arranged on the supporting surface, being assembled with other similar elements; in that the connection strip of each male side is intended to be disposed against the supporting surface, is joined to the exposed face by a projection of the male side, and presents a boss which is located between the projection of the male side and the free end of the strip and which extends substantially parallel to the edge of the plate equipped with this strip; and in that each female side presents a free end which is joined to the exposed face by a projection of the female side, a space for connection adapted to contain the boss of the strip of a male side of a similar adjacent assembling element being hollowed beneath the decorative assembling plate in the vicinity of said projection.

According to the invention, it is thus the same plate, called decorative assembling plate, which forms the exposed face of the assembling element and which bears the assembling means between the different elements that the male sides and the female sides constitute. The strip of the male sides is intended to be disposed directly against the surface of this support, to which it may, if necessary, be glued, nailed or clipped, possibly in complement of another fixation of the assembling element which will be specified hereinbelow. For the connection between two adjacent elements, the female side of a first element is simply placed on the male side of a second element, previously arranged on the supporting surface. Under these circumstances, the boss of the strip of this second element is contained in the space for connection made beneath the first element. The projection of the female side which joins the exposed face of the first element to the free end of its female side may be disposed precisely against the projection of the male side which joins the strip of the second element to its exposed face. This arrangement associated with the presence of the boss of the strip of the male side of the second element, avoids water penetrating under these elements and thus ensures seal.

For each female side, the space for connection of the female side of a first element is preferably adapted to contain the boss of the strip of a male side of a second similar adjacent assembling element when said female side is disposed on this strip, while preserving, between this boss and the zone of connection of the projection of the female side to the exposed face, a sealing volume adapted to contain a bead of sealing paste such as putty.

Under these circumstances, the seal is virtually perfect since the sealing volume, preserved on purpose beneath the exposed face of the first element, in the vicinity of its female side and above the boss of the strip of the second element, is advantageously used for disposing a sealing bead in this volume. The boss made on the strip of the second element, upon positioning of a female side of the first element on the strip of the second element, prevents the bead of paste arranged in the sealing volume from tending to creep beneath the first element. In effect, the boss tends, on the contrary, to compress this bead of paste against the projection of the female side. In this way, the bead of sealing paste is formed continuously at the join between the first and second elements.

Of course, it is possible to add to the sealing paste an adhesive agent which consolidates the bond between the two elements.

According to a particularly advantageous arrangement, for each male side, the boss presents a ramp which is inclined towards the projection of the male side which connects the strip to the exposed face.

For assembling a first element with a second element previously arranged on the supporting surface, the free end of the female side of the first element is guided by said ramp when it is positioned on the strip of the second element. Consequently, the ramp allows a precise positioning of the two elements with respect to each other. Furthermore, when a sealing volume is made in the space for connection, beneath the female side of the first element and above the boss of the strip of the second element, this ramp pushes the sealing paste back towards the zone of join between the projection of the female side of the first element and its exposed face, i.e. precisely in the region where the seal is necessary.

At least one of the afore-mentioned projections is advantageously formed in undercut.

The free end of each strip advantageously comprises a bracing band intended to maintain the upper face of the boss at a distance from the supporting surface.

A hollow volume is advantageously made beneath the boss of each strip, this volume being adapted to contain a bead of paste such as an adhesive or sealing paste.

The decorative assembling plate is very advantageously made by thermoforming from a sheet of thermoplastics material.

Manufacture of the decorative assembling plate in one piece, with the deformations constituted by the projections, the boss and the different elements mentioned above, is thus particularly simple and inexpensive.

### BRIEF DESCRIPTION OF THE DRAWINGS

The invention will be more readily understood on reading the following description of an embodiment given by way of non-limiting example, with reference to the accompanying drawings, in which:

FIG. 1 is a plan view of an assembling element according to the invention.

FIG. 2 is a view in section taken along a line corresponding to line II-II of FIG. 1, showing the region of the same element which is close to a male side and the region close to the female side of an adjacent element which is assembled thereon; and

FIG. 3 is a view in detail illustrating a variant embodiment.

### DESCRIPTION OF PREFERRED EMBODIMENTS

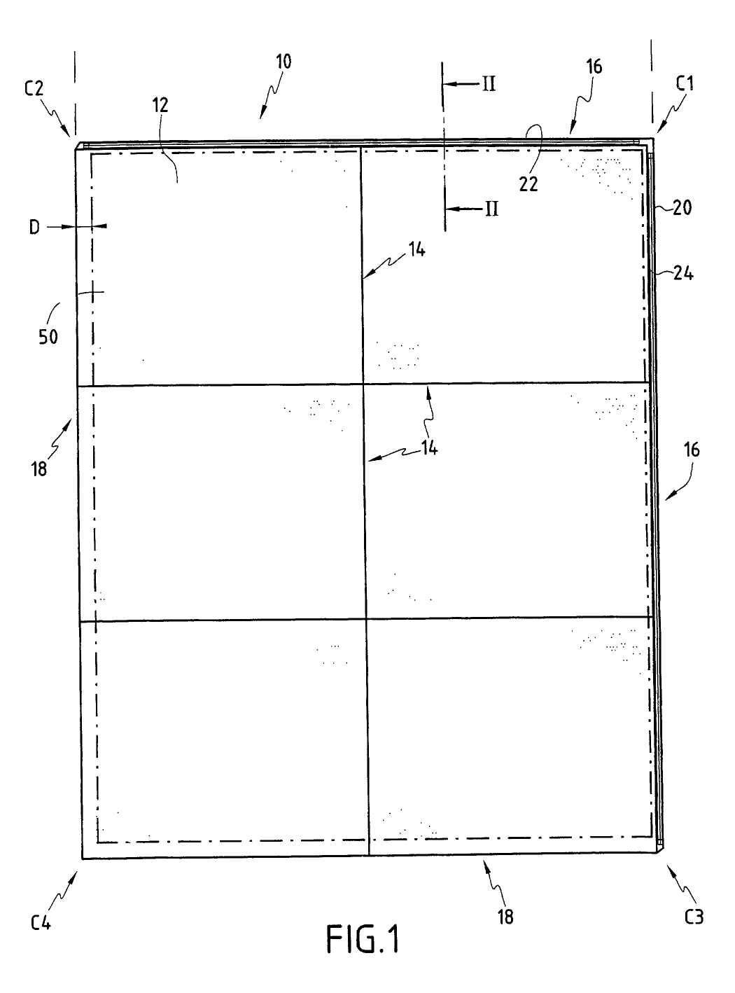

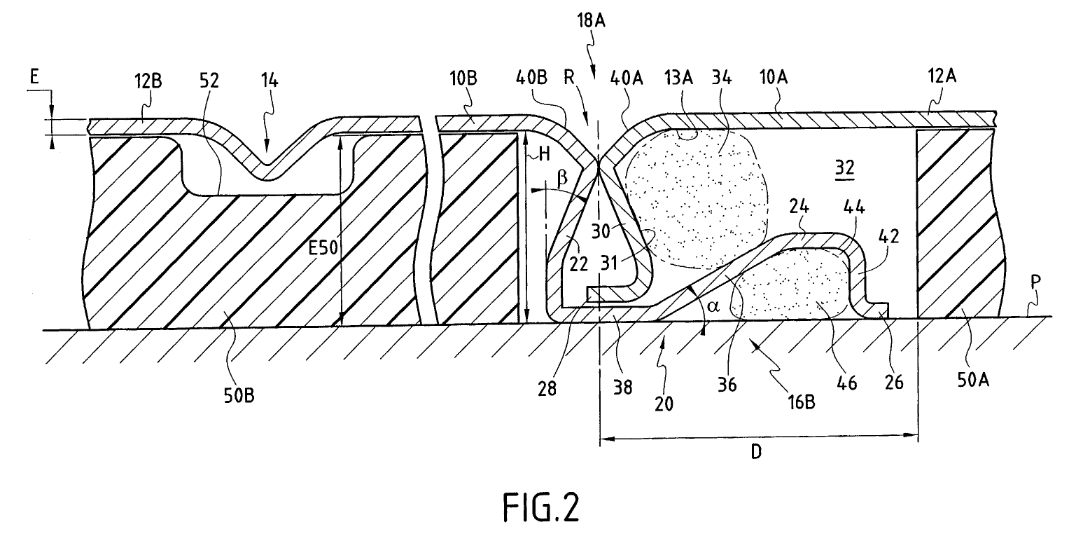

Referring now to the drawings, and firstly to FIG. 1, reference 10 denotes the decorative assembling plate of the assembling element. The section of FIG. 2 shows the assembly between the decorative assembling plate 10A of a first assembling element, of which the region close to a female side is seen, with the plate 10B of a second assembling element of which the male side is seen.

The assembling element is intended to be arranged on a supporting surface such as, in particular, a wall or a vertical partition. For example, a plurality of similar assembling elements are assembled with one another to form a covering of the supporting surface and thus to present the appearance of tiling. The assembling element shown in FIG. 1 presents the shape of a rectangle. Its dimensions are advantageously greater than those of a conventional tile: for example, they are of the order of 60 cm×50 cm. In order to enhance the imitation of tiling, the exposed face 12 of the plate 10 presents grooves 14 which simulate joints between tiles. Such a groove 14 made in the exposed face 12B of the plate 10B is also seen in FIG. 2.

Two adjacent edges of the plate 10 form two male sides 16, while its other two edges form female sides 18. FIG. 2 shows in section the male side 16B of the plate 10B and the female side 18A of plate 10A. In FIG. 2, reference P denotes the plane defined by the supporting surface on which elements are fixed. It is seen that their respective exposed faces 12A and 12B are substantially planar and parallel to this plane.

The male side 16B of the plate 10B comprises a connection strip 20 which is disposed against the plane P of the supporting surface. This strip is joined to the exposed face 12B by a projection 22. In other words, this projection 22 forms a step which extends between the exposed face 12B and the strip 20 and which determines the exposed thickness of the assembling element. The strip 20 also presents a boss 24 located between the projection 22 and its free end 26. Seen in plan view, this boss presents the form of a continuous rib parallel to the edge 16 of the assembling element and extending over virtually the whole length of this edge.

The female side 18A of the plate 10A presents a free end 28 which is joined to the exposed face 12A by a projection 30. A space 32 for connection is arranged beneath the plate 10A in the region close to its female side, i.e. in the region in which it is intended to be arranged above the strip 20 of the male side of another assembling element. The boss 24 of the male side 16B is contained in this space 32. The free end 28 of the first plate 10A comes into contact with the upper face of the strip 20. Moreover, the projections 22 and 30 are arranged against each other and contact each other in a region R.

The space 32 is large enough to contain the boss 24 while allowing a volume for seal to exist above this boss and below the plate 10A, in which volume a bead 34 of sealing paste is arranged. This bead is “jammed” between the boss 24 and the region located beneath the plate 10A facing it. Thanks to the boss, this bead is pushed against the inner surface 31 of the projection 30 and against the inner surface 13A of the exposed face 12A of the plate 10A.

The space 32 which contains the boss 24 is arranged beneath the exposed face of the plate and not beneath a strip. In this way, the existence of the boss 24 is invisible once the plate is laid and assembled with another similar plate. The projection 30 of the female side is arranged between the file end 28 of this side and the space 32.

Before assembling, the bead of paste is affixed on the strip 20 or, preferably (in order to avoid smears), beneath the plate 10A, in the angle formed between the projection 30 and the exposed face 12A.

The boss 24 presents a ramp 36 which is inclined towards the projection 22. This ramp thus pushes the bead of paste 34 in the desired direction. For example, the inclination α of this ramp with respect to the plane P is of the order of 25° to 60°, advantageously close to 30°.

The projection 22 is undercut with respect to the exposed face 12B. More precisely, its inclination β with respect to the perpendicular to the plane P is of the order of 15° to 45°, advantageously close to 20°. The projection 30 may also be undercut and present the same inclination as the projection 22. In that case, such inclination, associated with that of the ramp 36, promotes blockage of the bead 34 beneath the exposed face 12A and against the rear of the projection 30.

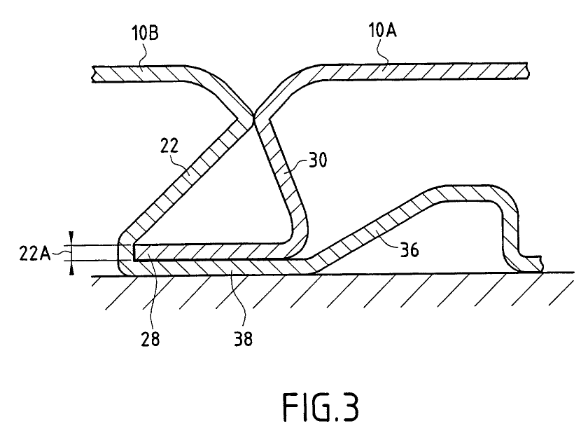

As shown in FIG. 3, the free end 28 of the plate 10A may cooperate with the projection 22 in order to fix the plate 10A in height with respect to plate 10B. To that end, the undercut part of this projection 22 is extended to a lower section 22A whose height is adapted to the thickness of the end 28 which comes into contact therewith. To the same end, it may be preferred to undercut the projection 30 so that it is retained against the projection 22.

Between the projection 22 which joins it to the exposed face 12B and the boss 24, the strip 20 presents a flat band 38 which is intended to be in contact with the supporting surface.

This flat band may possibly be clipped or nailed on the supporting surface. It also serves as reference plane to define the spaced apart relationship of the exposed face 12A of the adjacent assembling element with respect to this surface. In effect, the free end 28 of the female side presents a flat margin which rests on the flat band 38. It will be noted that the ramp 36 tends to push the projection 30 and the flat margin 28 towards the projection 22, this promoting the contact between the two projections in afore-mentioned zone R.

Between their exposed faces and these projections, the decorative plates present sloping portions, 40A and 40B respectively, for plates 10A and 10B. It is the noses of these slopes which contact each other in zone R. The slopes are arranged so that, considered together, they present a shape similar to that of the afore-mentioned grooves 14, with the result that, when a plurality of assembling elements are assembled on a support, their zones of join cannot, or can barely, be distinguished from grooves 14.

The slopes 40A and 40B may be formed by bevels or by curves suitably joined to the planar parts of the exposed faces.

The free end of the strip is also in the form of a flat band in contact with the supporting surface. It comprises a bracing band 42 which joins it to the boss 24. In this way, the upper face of this boss is maintained at a determined distance with respect to the supporting surface P. This avoids any tendency to crush the boss due to the presence of the bead 34.

Moreover, a hollow volume 44 is arranged beneath the boss 24 and, as shown in FIG. 2, it may contain another bead of paste 46, such as an adhesive or sealing paste.

The geometry of the male sides and of the female sides, as well as that of the grooves 14, may be obtained by simple deformations of a sheet of thermoplastics material, made by thermoforming. The thickness E of the decorative assembling plate is virtually constant despite the fact that the presence of the projections gives it a larger apparent thickness.

The assembling element of FIG. 1 comprises a lower plate 50 whose contour is indicated in dashed and dotted lines and which is located beneath the decorative assembling plate. FIG. 2 shows the lower plates 50A and 50B respectively located beneath plates 10A and 10B. In the region of the female sides, the plate 50A is spaced by a distance D with respect to the edge of the decorative assembling plate in order to preserve the afore-mentioned space 32. In the region of the male sides, the plate 50B may virtually extend until it comes against the back of the projection 22.

For each assembling element, the lower plate is formed by a continuous one-piece plate whose maximum thickness E50 is substantially equal to the maximum height H of the projections thereof. In actual fact, the thickness of the plate 50 is virtually constant over the whole of this plate except for the zones in which recesses 52 are made to house the elements in relief formed beneath the exposed face of the decorative assembling plates by the presence of the grooves 14.

The lower plate is advantageously made of a material of the expanded polystyrene type and said recesses 52 are formed simply by hot pressure. The lower plate is glued or heat-sealed beneath the exposed face of the assembling element.

When a plurality of assembling elements are assembled together, it is important that their respective exposed faces all be on the same plane. Due to the superposition of the female sides on the male sides, this requires that the apparent thickness of the decorative assembling plate vary between its different edges. This apparent thickness is measured on the edges of the plate, between the upper surface of its exposed face and, depending on the case, the free end 28 of a female side or the flat band 38 of a male side. In the present case, the apparent thickness of the plate varies continuously between a maximum thickness measured at corner C1 at which two male sides 16 join, and a minimum apparent thickness measured at corner C4 at which two female sides 18 join. The apparent thicknesses at corners C2 and C3 at which a male side and a female side join, are intermediate. For example, the thickness at corner C1 is of the order of 5 mm, while the thicknesses at corners C2 and C3 are of the order of 4.5 mm and the thickness at corner C4 is of the order of 4 mm.

What is claimed is:

1. An assembling element intended to be arranged on a supporting surface with other similar elements so as to form an assembly covering said supporting surface at least partially, for example in the manner of tiling, the element comprising two adjacent sides, called male sides, which are provided with a connection strip and two other adjacent sides, called female sides, one male side of one assembling element being intended to cooperate with a female side of a similar assembling element in order to assemble said elements, the element comprising a decorative assembling plate which is made in one piece and of which the edges form said male and female sides, this plate presenting a substantially planar exposed face which is intended to be exposed when the element is arranged on the supporting surface, being assembled with other similar elements, the connection strip of each male side being intended to be disposed against the supporting surface, being joined to the exposed face by a projection of the male side, and presenting a boss which is located between said projection and a free end of the strip and which extends substantially parallel to the edge of the plate equipped with this strip, and each female side presenting a free end which is joined to the exposed face by a projection of the female side, a space for connection adapted to contain the boss of the strip of a male side of a similar adjacent assembling element being hollowed beneath the decorative assembling plate in the vicinity of said projection of the female side.

2. The assembling element of claim 1, wherein, for each female side, the space for connection is adapted to contain the boss of the strip of a male side of a similar adjacent assembling element when said female side is arranged on this strip, while preserving, between this boss and the zone of connection of the projection of the female side to the exposed face, a sealing volume adapted to contain a bead of sealing paste such as putty.

3. The assembling element of claim 1, wherein, for each male side, the boss presents a ramp which is inclined towards the projection joining the strip to the exposed face.

4. The assembling element of claim 2, wherein, for each male side, the boss presents a ramp which is inclined towards the projection joining the strip to the exposed face.

5. The assembling element of claim 1, wherein at least one of the projections of the male side and of the female side is undercut.

6. The assembling element of claim 1, wherein each strip presents a flat band, which is located between the boss of this strip and the projection by which it is connected to the exposed face and which is intended to be in contact with the supporting surface.

7. The assembling element of claim 6, wherein the free end of each female side presents a flat margin adapted to rest on the flat band of the strip of a male side of a similar adjacent assembling element.

8. The assembling element of claim 1, wherein the free end of each strip comprises a bracing band intended to maintain the upper face of the boss at a distance from the supporting surface.

9. The assembling element of claim 3, wherein the free end of each strip comprises a bracing band intended to maintain the upper face of the boss at a distance from the supporting surface.

10. The assembling element of claim 4, wherein the free end of each strip comprises a bracing band intended to maintain the upper face of the boss at a distance from the supporting surface.

11. The assembling element of claim 1, wherein a hollow volume is arranged beneath the boss of each strip, this volume being adapted to contain a bead of paste such as an adhesive or sealing paste.

12. The assembling element of claim 1, wherein the decorative assembling plate is made by thermoforming from a sheet of thermoplastics material.

13. The assembling element of claim 1, wherein it further comprises a lower plate which is arranged beneath the exposed face of the decorative assembling plate and which presents a maximum thickness substantially equal to a maximum height of the projections thereof.

14. The assembling element of claim 13, wherein the exposed face of the decorative assembling plate presents grooves simulating joints between tiles, said grooves forming elements in relief beneath the exposed face, and the lower plate is formed in one piece and presents recesses adapted to house these elements in relief.

15. The assembling element of claim 14, wherein the lower plate is made of a material of expanded polystyrene type, and the recesses of this plate are formed by hot pressure.
